(19) United States
(12) Patent Application Publication
(10) Pub. No.: US 2006/0016355 A1
(43) Pub. Date: Jan. 26, 2006

(54) Flexographic pringting plate, flexographic printing device, production method for flexographic printing plate and production method for printing matter

(76) Inventors: Yuji Saai, Mie (JP); Takatoshi Kira, Nara (JP); Mitsuaki Morimoto, Nara (JP); Makoto Nakahara, Nara (JP); Shinichiro Kawabe, Tokyo (JP); Makoto Nakahara, Tokyo (JP); Yuichi Komura, Osaka (JP); Yoshimi Saito, Osaka (JP)

Correspondence Address: Edwards & Angell, LLP, P.O. Box 55874, Boston, MA, 02205, US

(21) Appl. No.: 10/532,166

(22) PCT Filed: Sep. 5, 2003
(86) PCT No.: PCT/JP03/11400

§ 371 Date: Apr. 20, 2005

(30) Foreign Application Priority Data
Oct. 21, 2002 (JP) 2002-305908

(51) Int. Cl. B41N 1/00

(52) U.S. Cl. 101/395

(57) ABSTRACT

A flexographic printing plate includes a raised part (2) for transferring a printing substance to a printing substrate, the raised part (2) having a top surface and a side, the top surface and the side forming an angle of not less than 90° and not more than 105°. More preferably, the top surface and the side form an angle of not less than 95° and not more than 100°. A flexographic printer includes a flexographic printing plate as described above.

### TECHNICAL FIELD

The present invention relates to a flexographic printing plate mounted on a flexographic printer. Further, the present invention relates to a flexographic printer.

### BACKGROUND ART

Flexography is a type of relief printing that uses a flexographic plate of flexible rubber or resin, and a liquid printing substance. Currently, printing substrates (note that a printing substrate is understood as any object on which printing is performed) that can be used for printing with this method include paper as well as cellophane and aluminum foil and the like.

FIG. 16 illustrates a printing unit that constitutes a key component of a flexographic printer. The printing unit includes an impression table 11 that supports a printing substrate 10, a flexographic printing plate 1 having a raised part 2, a plate cylinder 12, an anilox roll 16, a dispenser 18, and a doctor roll 15. Printing substance 17 such as ink is supplied to anilox roll 16 using dispenser 18. Anilox roll 16 and plate cylinder 12 are in the shape of cylindrical rolls and are rotated in the directions indicated by arrows 48 and 46, respectively.

Plate cylinder 12 includes, on its perimeter surface, flexographic printing plate 1 that has raised part 2 in a configuration that corresponds to the design to be printed. Raised part 2 and anilox roll 16 are disposed to be in contact with each other, while raised part 2 and printing substrate 10 are disposed to be in contact with each other. Printing substance 17 is applied to raised part 2 by anilox roll 16 coming in contact with raised part 2 and then transferred to printing substrate 10. Printing substrate 10 is disposed on a major surface of impression table 11 and is moved in the direction indicated by arrow 47 as printing proceeds. The transferred design is defined by the top surface configuration of raised part 2. The substance that has been transferred onto printing substrate 10 is hereinafter referred to as a “printed substance”. In the present example, the printed substance 4 is in the shape of a frame.

The curved perimeter surface of anilox roll 16 is contacted by raised part 2 as well as by doctor roll 15. Doctor roll 15 serves to uniformly spread printing substance 17 supplied by dispenser 18 over the perimeter surface of anilox roll 16. Thus, doctor roll 15 is disposed in contact with anilox roll 16 between the location where printing substance 17 is supplied and the location where it is in contact with raised part 2.

Besides a flexographic printer as shown in FIG. 16, a flexographic printer may also use a plate-like doctor blade that replaces, and functions similarly to, doctor roll 15. Further, a flexographic printer may include a cylindrical fountain roll that replaces, and functions similarly to, dispenser 18 to supply printing substance 17 to anilox roll 16.

Conventionally, flexography has been used for thinly printing a substance that has relatively low viscosities, as in e.g. printing characters and graphics onto packaging papers. However, as it may be employed in forming thin films, it is also used for other purposes than printing characters and graphics. For example, flexography may be used for forming alignment layers for a liquid crystal display, with a glass being the printing substrate and a polyimide thin film being printed on its surface. An alignment layer on a liquid crystal panel substrate may be fabricated using a substance with a viscosity ranging from approximately 0.001 Pa·s to 0.2 Pa·s printed with a thickness on the order of several hundred angstroms.

Flat panel displays using e.g. a liquid crystal panel are employed in a variety of devices such as mobile phones, personal digital assistants, televisions and the like. The liquid crystal panel thereof has liquid crystal that is sealed between a pair of panel substrates spaced apart at a predetermined distance. A thermosetting or UV curing seal is used to bond the panel substrates together along their periphery and to prevent the liquid crystal from leaking. In recent years, a method of manufacturing liquid crystal panels called “dropping and panel-alignment” method, or “dropping and filling” method, has gained in popularity. The method preforms a frame-shaped seal on one of a pair of panel substrates and then drops a predetermined amount of liquid crystal within the frame. The panel substrate is then bonded together with the other panel substrate under an atmosphere with reduced pressure before retrieving them to an atmosphere under normal pressure to produce a liquid crystal panel. The method allows the filling of liquid crystal and the bonding together of the two panel substrates simultaneously without leaving bubbles in the liquid crystal.

In conjunction with “dropping and panel alignment”, a method of placing a frame-shaped sealing material on a panel substrate using flexography is being developed that allows a seal to be formed without scratching the surface of a printing substrate and provides improved productivity.

Generally, a raised part of a flexographic printing plate manufactured according to the conventional art has a sloping side (see Japanese Patent Laying-Open No. 7-319150, for example). That is, the raised part has a top surface and a side that do not form an angle of 90° and has a trapezoidal cross section. FIG. 17A illustrates a plan view of a conventional flexographic plate, and FIG. 17B illustrates a cross sectional view thereof in the direction of the arrow of XVIIB-XVIIB in FIG. 17A. A flexographic printing plate 1 shown in FIGS. 17A and 17B has a raised part 2 in the shape of a near-quadrangular frame. Raised part 2 has a trapezoidal cross section and has a top surface and a side that form an angle larger than 90°. The difference when 90° is subtracted from the angle between the top surface and the side is hereinafter referred to as “inclination”. Inclination 5 in FIG. 17B is about 45°.

Flexographic printing plate 1 shown in FIGS. 17A and 17B is made of photosensitive resin. A method of manufacturing a flexographic printing plate according to the conventional art will now be described with reference to FIGS. 20 to 28. FIGS. 20 to 28 show various manufacturing steps in cross sectional views.

As shown in FIG. 20, a mask film 23 is placed on a major surface of the lower one, 25, of two glasses mounted on an exposure device (hereinafter referred to as the lower device glass). Mask film 23 is made of a material that is not transmissive to ultraviolet light and has an opening 24 to pass ultraviolet light therethrough. Opening 24 has a horizontal shape corresponding to that of the top surface of an intended raised part. As shown in FIG. 21, an acrylic-based photosensitive resin layer 19 with a thickness of 500 μm is placed on a major surface of mask film 23. Then, as shown in FIG. 22, a base film 22 is placed on a major surface of photosensitive resin layer 19. Base film 22 provides a mount for a stack formed in the manufacture of a flexographic printing plate and is formed of, for example, polyethylene terephthalate (PET). Subsequently, the upper one, 26, of the two glasses in the exposure device (hereinafter referred to as the upper device glass) is placed on a major surface of base film 22, as shown in FIG. 23.

As shown in FIG. 24, with photosensitive resin layer 19 being sandwiched by the two glasses of the exposure device, ultraviolet light at 250 mJ is directed toward base film 22 in a direction shown as exposure direction 41. Thus, a near-half portion of photosensitive resin layer 19 closer to its exposed side is cured and the opposite near-half is excited to a degree that does not cause it to be cured. Then, as shown in FIG. 25, ultraviolet light at 250 mJ is directed toward lower device glass 25 in a direction shown as exposure direction 42, where interposed mask film 23 only passes ultraviolet light through opening 24 to allow photosensitive resin layer 19 to be irradiated. During the exposure, ultraviolet light passed through opening 24 is diffracted as a consequence of the wave nature of light. Diffracted ultraviolet light, together with the excitement that was previously caused in the step shown in FIG. 24, effects curing of a tapering portion of photosensitive resin layer 19, located in the near-half thereof closer to mask film 23.

The resulting stack is removed from the exposure device, and mask film 23 is removed off from the stack. A development is then performed to remove the uncured portion thereof. The development leaves, on a major surface of base film 22, a photosensitive resin layer 19 having a raised portion as in FIG. 26. Finally, as shown in FIG. 27, the flexographic printing plate is completely cured by exposure to light at 1000 mJ directed in exposure direction 43 i.e. toward the side thereof having the raised portion. Flexographic printing plate 1 shown in FIG. 28 is thus manufactured. In the present example, raised part 2 has an inclination of 25°.

Any flexographic printing plate manufactured using conventional methods has a raised part with some inclination angle. A flexographic printing plate is pressed against a printing substrate during the transfer to the substrate. Certain inclination angles in the raised part advantageously minimize the bending of the raised part by the pressing force. In the case of a printing substance having a relatively low viscosity as in the conventional printing, a greater inclination in the raised part was advantageous.

In a method of manufacturing a liquid crystal panel, a sealing material may be placed on a major surface of the liquid crystal panel substrate where, generally, a UV curing sealing material is used as a printing substance, with its viscosity ranging from several ten Pa·s to several hundred Pa·s, e.g. 100 Pa·s. Unfortunately, when such a sealing material is printed using a flexographic printing plate with an inclination of 25° manufactured according to a conventional method, part of the printing substance applied to the top of the raised part is not transferred to the printing substrate, and repeated printing causes printing substance 17 to be accumulated on the sides of raised part 2, as shown in FIG. 18. The accumulation of substance on the sides of a raised part is hereinafter referred to as “printing substance residue”. Continued printing may cause, at some point, accumulated substance to be transferred such that the shape of the printed substance is not identical with that of the top surface of the raised part. As shown in FIG. 19, printed substance 4 may have a larger line width, which is sometimes called a ball, 31. Especially a printed substance 4 having a bent portion suffers from increased frequency of balls 31 being produced there.

A flexographic printing plate with an inclination of 25° was tested for the printing substance residue and the print quality using substances of different viscosities, of which the results are shown in Table 1.

TABLE 1

Viscosity [Pa · s]

| | 0.5 | 5 | 50 | 500 |
|---|---|---|---|---|
| Printing substance | ◯ | ◯ | X | X |
| residue | | | | |
| Print quality | ◯ | ◯ | X | X |

Printing substance residue ◯: no residue X: residue present
Print quality ◯: no ball X: ball present

To evaluate the results, the raised part and the printed substance were observed microscopically. For the substance residue, it was determined whether or not substance residue was observed at the raised part. The print quality means how appropriate the shape of the printed substance is, where it was determined in the tests whether or not a ball was generated in the printed substance. For printing substances with relatively low viscosities of 0.5 Pa·s and 5 Pa·s, neither substance residue nor a ball were produced which means good print quality, whereas for printing substances with relatively high viscosities of 50 Pa·s and 500 Pa, substance residue and a ball were produced.

The present invention attempts to solve problems as described above. An object of the present invention is to provide a flexographic printing plate and a flexographic printer that can provide a printed substance precisely in the shape corresponding to that of the top surface of a raised part of the flexographic printing plate even when using a printing substance with high viscosities. Another object of the present invention is to provide a method of manufacturing a flexographic printing plate having a raised part with reduced inclination angle compared to the conventional art. A further object of the present invention is to provide a method of producing a printed substance with alleviated problems e.g. a ball.

### DISCLOSURE OF THE INVENTION

A flexographic printing plate according to the present invention includes a raised part for transferring a printing substance to a printing substrate, the raised part having a top surface and a side, the top surface and the side forming an angle of not less than 90° and not more than 105°. Preferably, the angle is not less than 95° and not more than 100°. Such an arrangement with reduced inclination can minimize substance residue on the raised part, providing a printed substance in the shape corresponding to that of the raised part.

In the invention described above, the top surface is preferably shaped as a line when viewed from above, and has a bent portion. A ball, one of the problems in a printed substance, is frequently generated at a bent portion. The reduction in the generation of balls is particularly significant in a flexographic printing plate with such a configuration.

A flexographic printer according to the present invention includes a flexographic printing plate as described above. This arrangement may provide a flexographic printer capable of preventing a ball from being produced during printing.

A method of producing a printed substance according to the present invention uses a flexographic printing plate as described above to perform the printing. This method may provide a printed substance with reduced occurrence of balls being generated.

In the present invention described above, a printing substance with a viscosity of not less than 40 Pa·s is preferably used. A ball is often generated in a printed substance with a viscosity of 40 Pa·s or more. The reduction in the occurrence of balls being generated by employing the present method is particularly significant in such a situation.

A method of manufacturing a flexographic printing plate having a photosensitive resin as its main material according to the present invention includes the step of forming an underlayer, where a first photosensitive resin layer on a major surface of a base film is exposed to light to form the underlayer; the step of placing a second photosensitive resin layer on a major surface of a mask film for exposure in a desired geometry; and the step of stacking a major surface of the underlayer and a major surface of the second photosensitive resin layer in contact with each other. The method further includes the step of main exposure, where the stack resulting from the step of stacking is exposed to light on the side thereof having the mask film thereon; and the step of development where a development after the main exposure forms a raised part. Separating a resin layer forming an underlayer of a flexographic printing plate from a resin layer forming a raised part according to the present method allows the inclination angle of the raised part to be reduced compared with that conventionally manufactured.

In the invention described above, the first photosensitive resin layer and the second photosensitive resin layer are preferably made of one photosensitive resin. This eliminates the need to provide different kinds of photosensitive resin and allows exposure using the same method to provide improved productivity.

In the invention described above, the step of forming an underlayer preferably includes the step of exposing the side of the first photosensitive layer opposite the side to be in contact with the second photosensitive resin layer. In other words, the first photosensitive resin layer is exposed to light on the side thereof having the base film disposed thereon. In this way, the side of the first photosensitive resin layer opposite the side bonded to the base film may be cured more slowly. Thus, in the subsequent main exposure, the first photosensitive resin layer is bonded to the second photosensitive layer with improved strength.

In the present invention described above, the main exposure preferably includes controlled exposure where the side of the stack opposite the side having the mask film disposed thereon is exposed. More preferably, the controlled exposure includes exposure only in an amount that will result in a desired angle between the top surface and the side of the raised part to be formed. A larger amount of exposure in the controlled exposure results in greater inclination angle of the raised part. Thus, the inclination can be regulated by changing the amount of exposure.

The invention described above preferably includes exposing the side of a printing plate resulting from the development having a raised part thereon. This allows completely curing the flexographic printing plate while bonding the first photosensitive resin layer completely with the second photosensitive resin layer.

### BRIEF DESCRIPTION OF THE DRAWINGS

FIG. 1A is a plan view of a flexographic printing plate according to a first embodiment of the present invention.

FIG. 1B is a cross sectional view thereof in the direction of the arrow of IB-IB in FIG. 1A.

FIG. 2A is a plan view illustrating an example of a bent portion of a raised part of a flexographic printing plate.

FIG. 2B is a plan view illustrating another example of a bent portion.

FIGS. 3 to 15 illustrate various steps in a method of manufacturing a flexographic printing plate according to a second embodiment of the present invention.

FIG. 16 is a perspective view of a flexographic printer and shows key components thereof.

FIG. 17A is a plan view of a conventional flexographic printing plate.

FIG. 17B is a cross sectional view thereof in the direction of the arrow of XVIIB-XVIIB in FIG. 17A.

FIG. 18 is a cross sectional view of a raised part illustrating printing substance residue on a conventional flexographic printing plate.

FIG. 19 illustrates problems in a substance printed by a conventional flexographic printing plate.

FIGS. 20 to 28 illustrate various steps in a method of manufacturing a flexographic printing plate according to the conventional art.

### BEST MODE FOR CARRYING OUT THE INVENTION

### First Embodiment

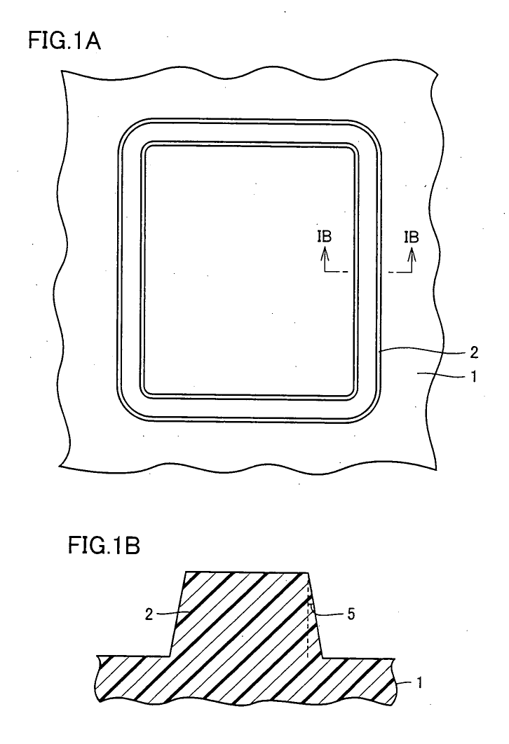

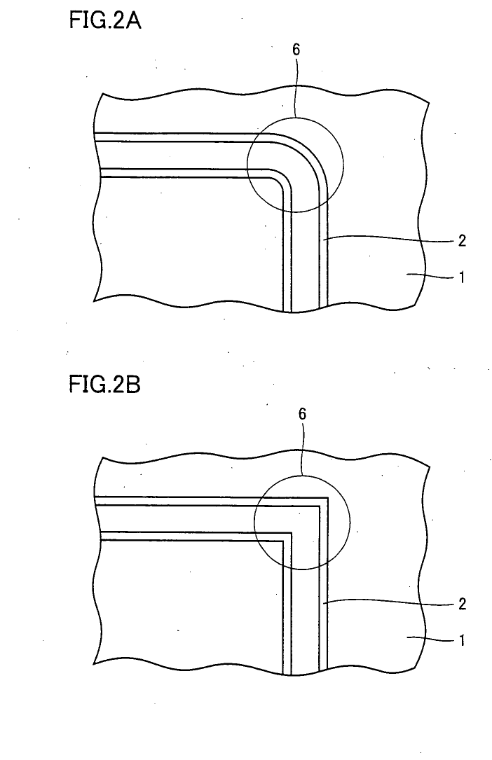

Referring to FIGS. 1A to 2B, a flexographic printing plate according to a first embodiment of the present invention will be described.

A flexographic printing plate is a relief printing plate in a flexographic printer for transferring a substance such as ink. FIGS. 1A and 1B show a flexographic printing plate according to the first embodiment of the present invention. FIGS. 1A and 1B show one raised part formed on a flexographic printing plate, of which FIG. 1A is a plan view and FIG. 1B is a cross sectional view in the direction of the arrow of IB-IB in FIG. 1A. Flexographic printing plate 1 has a raised part 2 on a major surface, where raised part 2 according to the present embodiment is shaped as a line when viewed from above and is in the shape of a near-quadrangular frame. The corners of the near-quadrangle are arced. Raised part 2 has a trapezoidal cross section as shown in FIG. 1B, and is constructed such that the shorter one of the two parallel sides forms the upper surface of flexographic printing plate 1. Raised part 2 has a top surface and a side, where printing substance is applied to the top surface and is transferred to a printing substrate. Inclination angle 5 according to the present embodiment is 10°. In other words, the angle between the top surface and the side of raised part 2 is 100°.

A flexographic printing plate according to the present invention is characterized by a small angle between the top surface and the side of raised part 2 or, referring to FIG. 1B, by a smaller inclination 5 than that resulting from a conventional method. A smaller inclination angle prevents balls from being generated in the printed substance, thereby providing a good printed substance. Flexographic printing plates having a raised part in the shape of a near-quadrangular frame as shown in FIGS. 1A and 1B with different inclination angles were tested. The flexographic printing plate with an inclination of 25° was manufactured by a conventional method of manufacturing a flexographic printing plate, while the flexographic printing plates with inclinations of 20° or less were manufactured by a method according to a second embodiment of the present invention, as described below. The results from the tests are shown in Table 2. The tests used a flexographic printing plate including a raised part having a top surface 100 μm in width and having a height of 200 μm. A microscopic observation provided the evaluation.

TABLE 2

Inclination

| | 0° | 5° | 10° | 15° | 20° | 25° |
|---|---|---|---|---|---|---|
| Printing substance | ◯ | ◯ | ◯ | Δ | X | X |
| residue | | | | | | |
| Print quality | Δ | ◯ | ◯ | Δ | X | X |

Printing substance residue ◯: no residue X: residue present
Print quality ◯: no waviness or ball X: waviness or ball present

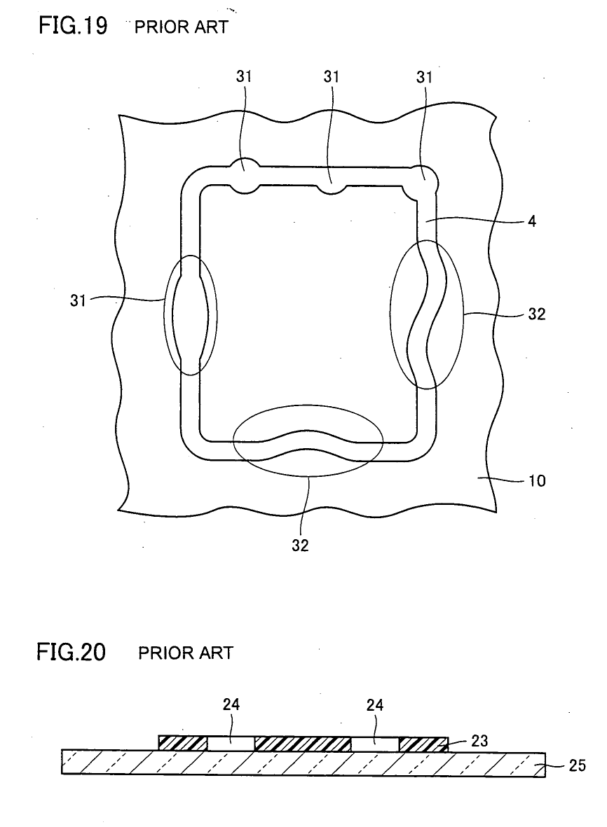

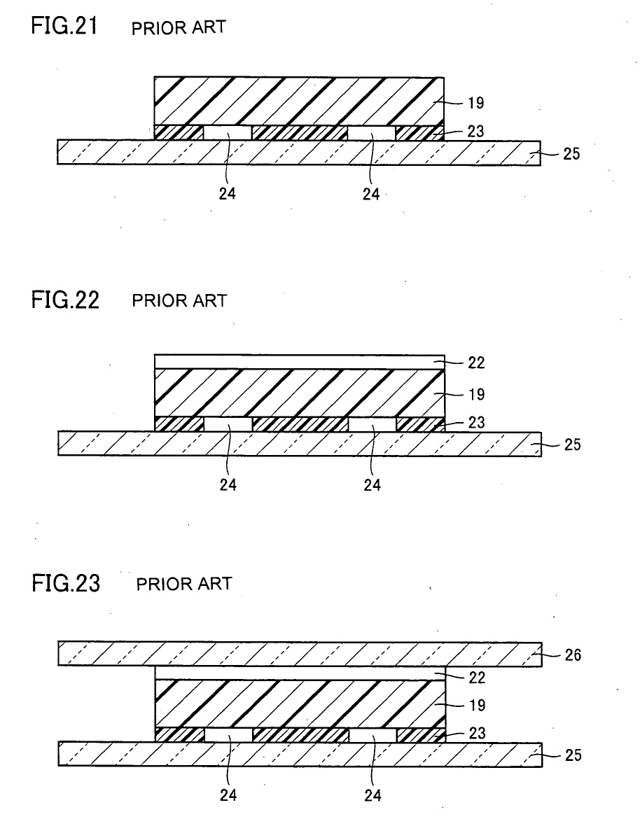

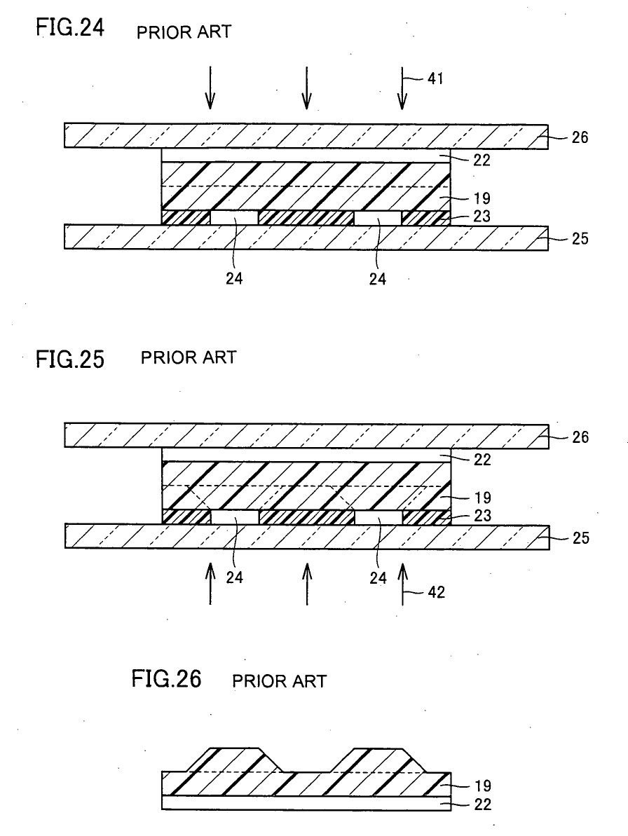

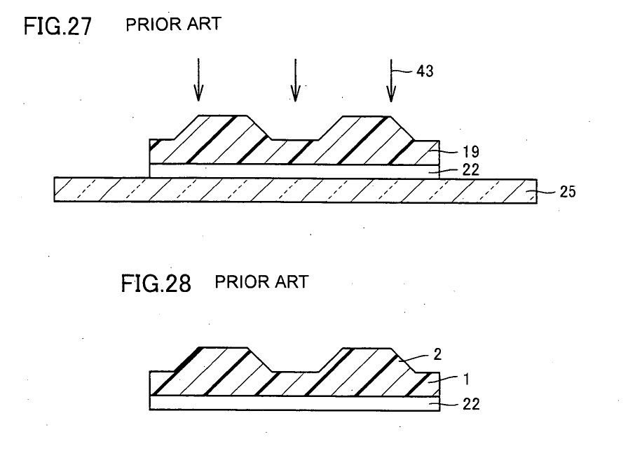

Besides balls, “waviness” was observed as well in the evaluation of print quality. A waviness is a portion of substance deviating from its intended shape, forming a wave. FIG. 19 shows an example of waviness 32. A curved waviness 32 was generated at a location where the printed substance was supposed to form a line. The quality of the printed substance was determined based on whether or not wavinesses or balls were produced. In the tests, good print quality means that neither balls nor wavinesses were produced and that a printed substance in the shape corresponding to that of the raised part was achieved.

Printing substance residue was inspected while the inclination was increased. Substance residue was produced for an inclination of 15°, and was found in significant amounts for an inclination of 20° and more. The print quality also started to deteriorate at 15°, and an inclination of 20° and more resulted in a significant occurrence of wavinesses and balls being produced. “A”, as shown for the inclination of 15°, means a slight occurrence of balls being generated that substantially has no adverse effect. The tests used a printing substance with a viscosity ranging from 50 Pa·s to 350 Pa·s, and similar results were found for any viscosity within this range.

These results demonstrate that the smaller the inclination, the higher the print quality for a printing substance with a relatively high viscosity. However, while the raised part with an inclination of 0° provided good results in terms of the substance residue, it caused problems in terms of the print quality i.e. produced wavinesses, since a flexographic printing plate is pressed against a printing substrate with a certain compressive force, bending the raised part and causing wavinesses. Smaller inclination angles may often result in the raised part being bent, which produces wavinesses. The results show that wavinesses were generated only at the inclination of 0° and to a degree that substantially has no adverse effect on the printed substance.

An inclination angle less than 0° (i.e. a raised part being constructed such that the longer one of the parallel sides of its trapezoidal cross section forms its top surface) is expected to cause more wavinesses as well as substance residue. The tests used a flexographic printing plate including a raised part having a top surface 100 μm in width, which is relatively small compared with its height of 200 μm. Greater line width (width of the top surface) is expected to cause less wavinesses.

Thus, an inclination of the raised part not less than 0° and not more than 15° can minimize the printing substance residue, providing a printed substance with good print quality. Preferably, the inclination angle is not less than 5° and not more than 10°. In other words, an angle between the top surface and the side of the raised part of not less than 90° and not more than 105° provides good printed substance, where an angle of not less than 95° and not more than 100° is preferable. As for the viscosity of the printing substance, more effect can be achieved for larger viscosities. And particularly, good printed substance compared with that produced by a conventional flexographic printing plate can be obtained for a printing substance with a viscosity of 40 Pa·s and larger.

Balls, one of the problems in the printed substance, are produced at a bent portion of a raised part of a flexographic printing plate with relatively large frequencies. Two forms of bent portions are shown in plane views in FIGS. 2A and 2B. FIG. 2A shows a raised part 2 having an arced bent portion 6. FIG. 2B shows a bent portion 6 shaped like a sharp knee. In any of these forms, a flexographic printing plate according to the present invention achieves the prevention of generation of balls, providing a printed substance precisely in the shape corresponding to that of the raised part.

A flexographic printing plate according to the present invention can be mounted on a flexographic printer in a similar fashion to a conventional flexographic printing plate. For example, an inventive flexographic printing plate may be bonded to a plate cylinder 12 of a flexographic printer such as shown in FIG. 16. Such a printer can provide a printed substance with improved print quality, or, a method of producing a printed substance with alleviated problems such as balls may be provided.

### Second Embodiment

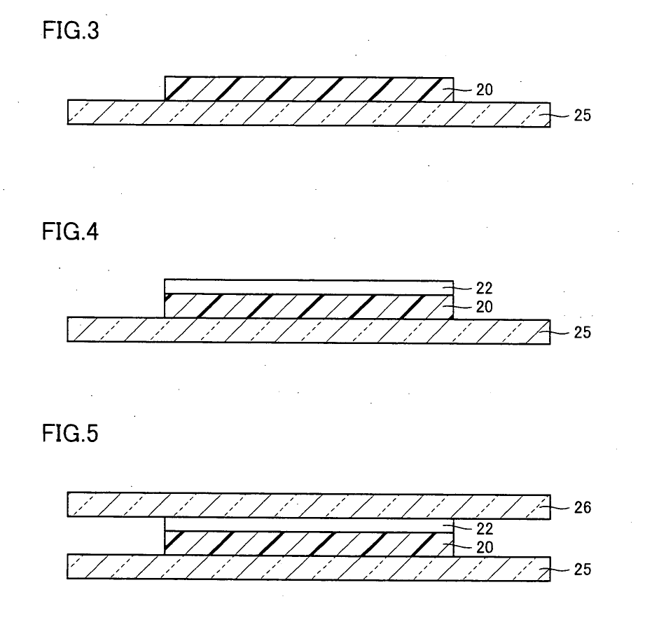

Referring to FIGS. 3 to 15, a method of manufacturing a flexographic printing plate according to a second embodiment of the present invention will be described. FIGS. 3 to 15 show various steps in cross sectional views.

In FIG. 3, a first photosensitive resin layer 20 with a thickness of 1 mm is formed on a major surface of a lower device glass 25 mounted on an exposure device. First photosensitive resin layer 20 is an acrylic-based photosensitive resin. Next, as shown in FIG. 4, a base film 22 is placed on the upper surface of first photosensitive resin layer 20. Base film 22 is a sheet made of PET, although it may be substituted by a sheet of any other material that has no irregularities on its surface and is transmissive to ultraviolet light. As shown in FIG. 5, an upper device glass 26 is placed on the upper surface of base film 22 such that first photosensitive resin layer 20 and base film 22 are sandwiched by the two glasses of the exposure device.

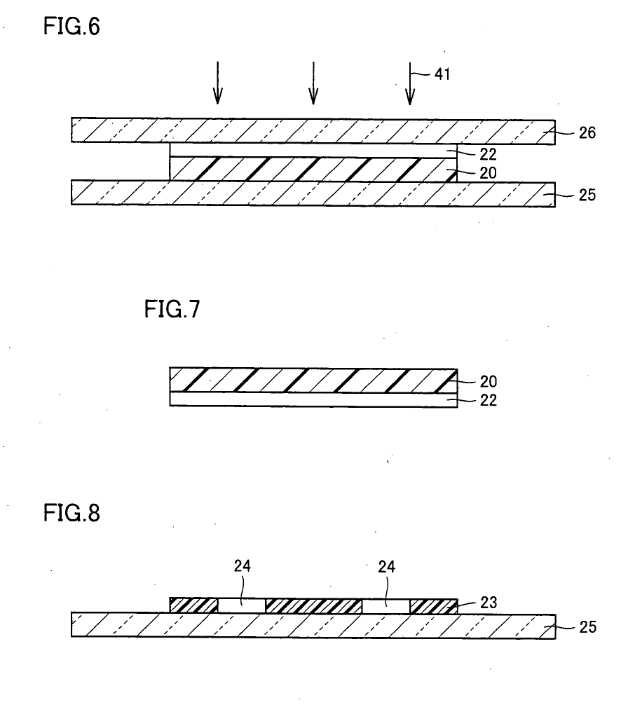

First photosensitive resin layer 20 is now exposed to light on the side near base film 22 in exposure direction 41, as shown in FIG. 6, to a degree that does not cause complete curing. In the present embodiment, the exposure is conducted at 200 mJ. As a result of the exposure, the side of first photosensitive resin layer 20 in contact with base film 22 is cured to the greatest degree. The exposure direction may be an opposite one to exposure direction 41. However, the surface of the first photosensitive resin layer to be later bonded to a second photosensitive resin layer (i.e. the side opposite the one in contact with the base film) is preferred to be just excited only and be incompletely cured thereby providing improved adherence with the second photosensitive resin layer. Thus, exposure in direction 41 is more preferable. Once the exposure is completed, the stack is removed from the exposure device to provide a stack having first photosensitive resin layer 20 and base film 22, as shown in FIG. 7. First photosensitive resin layer 20 forms the foundation on which a raised part of the flexographic printing plate can be formed, and is herein referred to as “underlayer”.

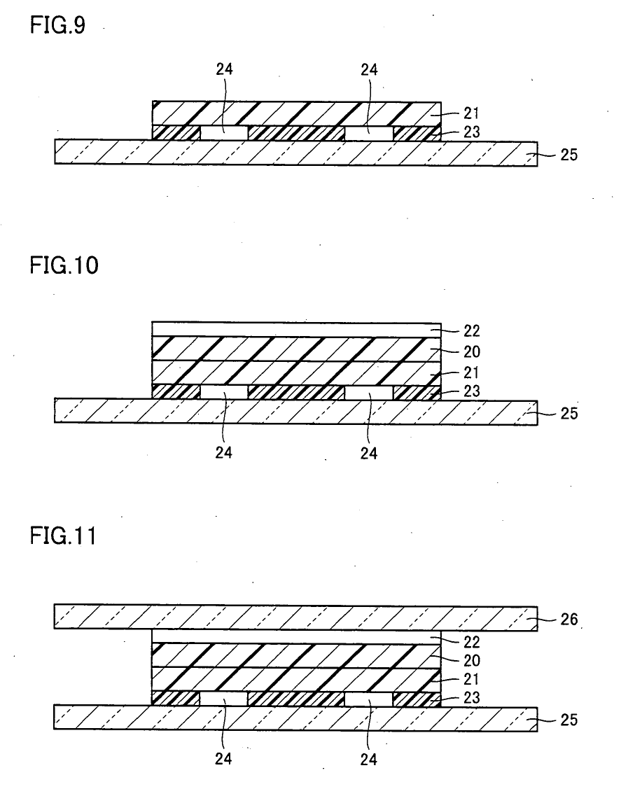

As shown in FIG. 8, a mask film 23 is placed on a major surface of lower device glass 25. Mask film 23 has an opening 24 for passing ultraviolet light of the exposure device, where the shape of opening 24 corresponds to the shape of the top surface of a raised part of the flexographic printing plate to be produced. Opening 24 has been pre-fabricated so as to allow exposure in a desired geometry. Next, as shown in FIG. 9, a second photosensitive resin layer 21 with a thickness of 200 μm is applied to a major surface of mask film 23 and, as shown in FIG. 10, the stack shown in FIG. 7 is overlaid on a major surface of second photosensitive resin layer 21 such that a major surface of first photosensitive resin layer 20 of the stack in FIG. 7 is in contact with the major surface of second photosensitive resin layer 21. At this stage, counting from lower device glass 25, mask film 23, second photosensitive resin layer 21, first photosensitive resin layer 20, and base film 22 are stacked upon each other in this order. An upper devices glass 26 is placed on the upper surface of the resulting stack (a major surface of base film 22) to sandwich the stack with the two device glasses as shown in FIG. 11.

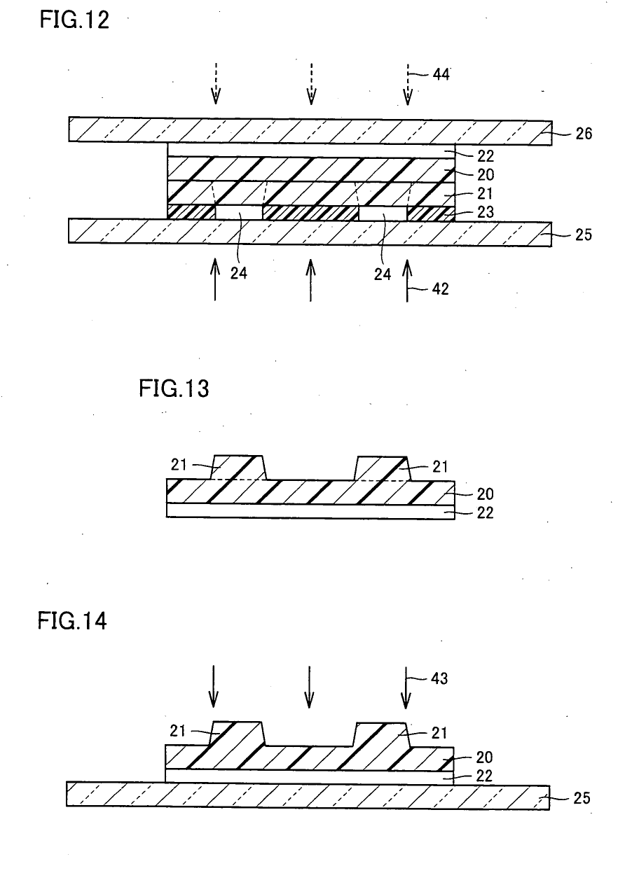

The step of main exposure is then performed in which the portion of the stack to be a raised part is cured. FIG. 12 illustrates the main exposure. The exposure is performed mainly in exposure direction 42 i.e. toward the side of the stack having mask film 23 thereon, to cure the portion that is to be a raised part. The portion of second photosensitive resin layer 21 exposed to light through opening 24 in mask film 23 is cured. The side of the stack opposite the side having mask film 23 may also be exposed, depending on the desired inclination angle for the raised part. That is, in FIG. 12, exposure is performed in a direction shown as exposure direction 44. By this controlled exposure, the inclination angle to be formed can be regulated. The inclination angle may be increased by increasing the amount of exposure in direction 44, while the inclination angle may be reduced by decreasing the amount of exposure in direction 44. For example, an exposure at 250 mJ in exposure direction 42, with the amount of exposure in direction 44 being zero, can provide a flexographic printing plate having a raised part with an inclination of 0°. Exposure in direction 44 mainly serves to excite second photosensitive resin layer 21, whereas exposure in direction 42 serves to cure the portion of the stack that is to be a raised part. Consequently, the amount of exposure in direction 42 is usually higher than that in direction 44. The amount of exposure may be changed by changing the duration of exposure or by changing the light intensity.

Once the main exposure is completed, the stack is removed from the exposure device, mask film 23 is removed, and a development is performed to remove the uncured portion of the stack. The development leaves the cured portion of the second photosensitive resin layer and the underlayer, thereby providing a stack in which the remaining portion of second photosensitive resin layer 21 forms a raised part, as shown in FIG. 13. Finally, as shown in FIG. 14, exposure is performed in a direction shown as exposure direction 43 i.e. toward the side of the stack having the raised part. This step causes the surface of the two photosensitive resin layers to be completely cured while bonding underlayer 3 completely with second photosensitive resin layer having the raised part. For example, exposure is performed at 1000 mJ for a flexographic printing plate having a raised part with an inclination of 0° as mentioned above.

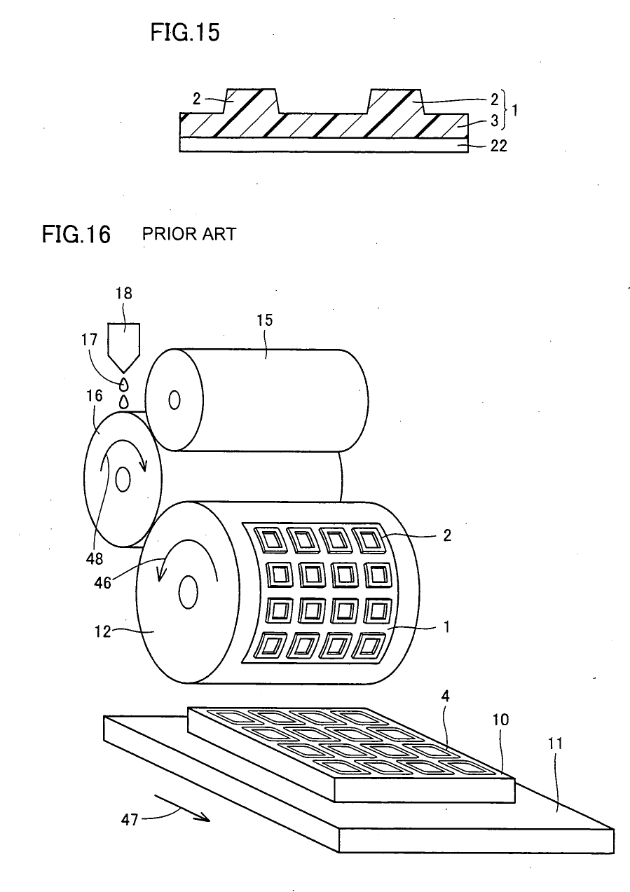

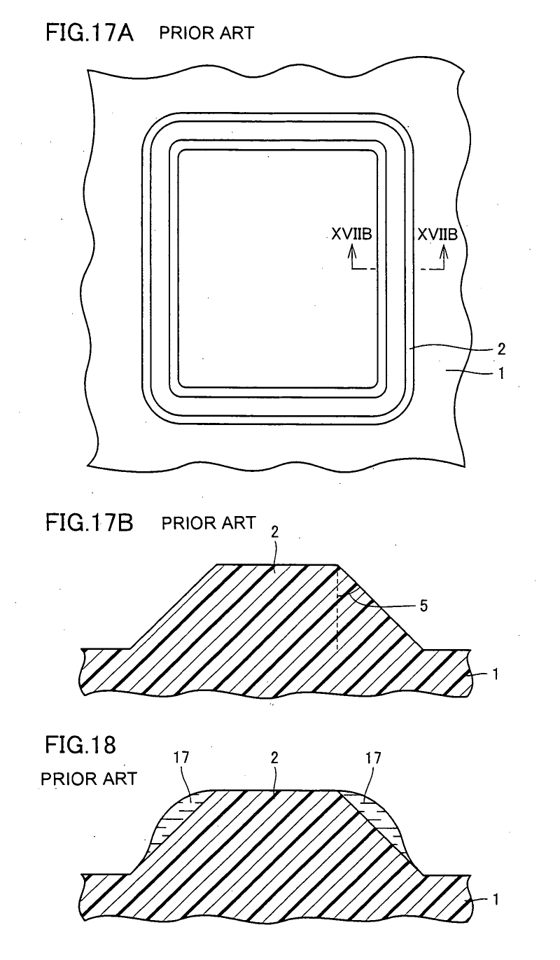

Thus, a flexographic printing plate 1 may be provided having a raised part 2 with controlled inclination angle on an underlayer 3 as shown in FIG. 15. Base film 22 may be peeled away from flexographic printing plate 1 before use, or may remain integrally joined with the flexographic printing plate when it is mounted on a flexographic printer.

Manufacturing a flexographic printing plate by a manufacturing method as described above can reduce the inclination angle of the raised part compared with that manufactured by the conventional art. Further, in the step of main exposure, the inclination angle for the raised part can be controlled by regulating the amount of exposure on the side of the stack opposite the side on which a raised part is to be formed.

In the present embodiment, the second photosensitive resin layer is preferably made of the same resin as the first photosensitive resin layer. Using the same resin material allows a flexographic printing plate to be manufactured by one exposure method, thereby providing improved productivity.

A flexographic printing plate according to the present invention as described above is particularly effective for a printing substance with high viscosities, although it is not limited to a substance with high viscosities.

As described above, the present invention can provide a flexographic printing plate and a flexographic printer capable of producing a printed substance precisely in the shape corresponding to that of the top surface of a raised part of the flexographic printing plate even for a printing substance with a high viscosity. Further, the present invention can provide a method of manufacturing a flexographic printing plate that allows the inclination angle of a raised part thereof to be smaller than would be achieved by the conventional art. Moreover, the present invention can provide a method of producing a printed substance with alleviated problems such as balls.

The embodiments disclosed herein are by way of example only and are not by way of limitation. The scope of the present invention is set forth in the claims rather than the above description, and includes all the modifications within the spirit and scope equivalent to those defined in the claims.

### INDUSTRIAL APPLICABILITY

The present invention is suitable for printing that requires precise transfer of substance in the shape corresponding to that of the top surface of a raised part of a printing plate, and particularly suitable for printing that requires precise transfer of a printing substance with high viscosities to a printing substrate.

1. A flexographic printing plate including a raised part for transferring a printing substance to a printing substrate,
said raised part Shaving a top surface and a side, and
said top surface and said side forming an angle of not less than 90° and not more than 105°.

2. The flexographic printing plate according to claim 1, wherein said angle is not less than 95° and not more than 100°.

3. The flexographic printing plate according to claim 1, wherein said top surface is shaped as a line when viewed from above, and has a bent portion.

4. A flexographic printer including the flexographic printing plate according to claim 1.

5. A method of producing a printed substance, wherein printing is performed using the flexographic printing plate according to claim 1.

6. The method of producing a printed substance according to claim 5, wherein printing is performed using a printing substance with a viscosity of not less than 40 Pa·s.

7. A method of manufacturing a flexographic printing plate having a photosensitive resin as its main material, comprising:
the step of forming an underlayer where a first photosensitive resin layer disposed on a major surface of a base film is exposed to light to form the underlayer;
the step of placing a second photosensitive resin layer on a major surface of a mask film for performing exposure in a desired geometry;
the step of stacking a major surface of said underlayer and a major surface of said second photosensitive resin layer in contact with each other;
the step of main exposure where a stack resulting from said step of stacking is exposed to light on the side having said mask film disposed thereon; and
the step of development where, following said step of main exposure, a development is performed to form a raised part.

8. The method of manufacturing a flexographic printing plate according to claim 7, wherein both said first photosensitive resin layer and said second photosensitive resin layer are made of one photosensitive resin.

9. The method of manufacturing a flexographic printing plate according to claim 7, wherein said step of forming an underlayer includes the step of exposing the side of said first photosensitive resin layer opposite the side to be in contact with said second photosensitive resin layer.

10. The method of manufacturing a flexographic printing plate according to claim 7, wherein said step of main exposure includes the step of controlled exposure where the side of said stack opposite the side having said mask film disposed thereon is exposed.

11. The method of manufacturing a flexographic printing plate according to claim 10, wherein said step of controlled exposure includes exposure at an amount of exposure that will produce a desired angle between the top surface and the side of said raised part to be formed.

12. The method of manufacturing a flexographic printing plate according to claim 7, including the step of exposing a side of a printing plate resulting from said step of development, said side of the printing plate being the one having said raised part formed thereon.
